(19) United States
(12) Patent Application Publication
(10) Pub. No.: US 2009/0213572 A1
(43) Pub. Date: Aug. 27, 2009

(54) INTERACTIVE ACTUATABLE WEARABLE DISPLAY

(75) Inventors: Todd R. Benson, Atlanta, GA (US); Ronald Gregory, Hong Kong (CN); Joseph Fernandez, Hong Kong (CN)

Correspondence Address: STOEL RIVES LLP - SLC, 201 SOUTH MAIN STREET, SUITE 1100, ONE UTAH CENTER, SALT LAKE CITY, UT, 84111, US

(73) Assignee: Envisage, Atlanta, GA (US)

(21) Appl. No.: 12/361,476

(22) Filed: Jan. 28, 2009

Related U.S. Application Data
(60) Provisional application No. 61/024,123, filed on Jan. 28, 2008.

(51) Int. Cl. F21L 4/02; H05B 37/02; G09F 13/04

(52) U.S. Cl. 362/97.1; 315/159; 315/313; 315/362; 362/183

(57) ABSTRACT

A display apparatus that can be worn by a user, attached to a surface, and/or comprise a stand-alone display containing a light source that emits light and is positioned so as to illuminate a design on the surface of the display apparatus, and/or that incorporates a lighted surface or video-capable technology and that may be connected to a microprocessor and/or light, sound or motion sensor functionalities connected to a microprocessor that can interpret external stimulus and modify the display according to various criteria to attract viewers. The display apparatus also is connected to or in the case of a wearable display contains a power supply that provides power to the light source or lighted display technology and microprocessor and/or sensor functionalities. In some embodiments, the invention may also include a promotional display member that displays advertising or sponsoring information. This promotional display member is configured to attach to display apparatus and surround the design on the front surface of the display apparatus.

### CROSS REFERENCE TO RELATED APPLICATIONS

This application claims the benefit of priority to U.S. Provisional Patent Application No. 61/024,123, filed on Jan. 28, 2008, entitled “Interactive Actuatable Wearable Display,” the entire contents of which are incorporated herein by reference.

### THE FIELD OF THE INVENTION

This invention relates to display apparatus, including apparatus that can be worn by users, displayed on a stand-alone basis, and/or attached to surfaces used to display designs, slogans, advertisements, pictures, or any other type of information as desired, and that can be actuated, controlled, modified or adjusted based on external stimulus.

### BACKGROUND

Display apparatuses are widely created and used to display information, market commercial products, promote political candidates, and/or to simply provide amusement to observers and/or the person employing the display apparatus. A number of different types of displays have been utilized for such purposes including billboards, signs, banners, decals, pins, bumper stickers, and the like. The information included on such display apparatuses can include designs, slogans, advertisements, messages, and pictures. Such apparatuses are commonly used by commercial entities, political organizations, charitable organizations, educational institutions, and other large entities to promote their various endeavors.

Fixed placement display apparatuses are one type of display apparatus that are commonly used. Billboards and lighted displays of various sizes are one type of display apparatus that are commonly used. One advantage of such apparatuses is that they can be placed in highly visible locations where they will be seen by the maximum number of people.

A major problem with fixed placement display apparatuses is that they do not interact with the public. Some displays have been developed that intermittently alternate the display, but typically not in response to external stimuli from the environment nor the public. This results in limited effectiveness, impact, and desired response.

User wearable display apparatuses are another type of display apparatus that are commonly used. There are many advantages for using user wearable display apparatuses. One advantage is that most apparatuses are usually small and therefore easy and convenient to use. An additional advantage provided by user wearable display apparatus is that the promoted product, campaigning individual or company is associated with a patron, supporter or brand. Once the display apparatus is affixed to a user, it can potentially attract viewers wherever the user carries it. The public can view the apparatus while the wearer participates in normal daily activities, such as talking to neighbors or friends, going shopping, walking down a street or through a public area, etc. or participating in other activities, such as attending a concert, sporting event or political campaign event, etc.

Display apparatuses are usually affixed to a user, in a manner intended to display information to the public. A major problem occurring with display apparatuses and the accompanying designs, however, is that some designs may not be sufficiently noticeable to achieve the desired degree of attention from the public. This can be caused by many things, such as, for example, lack of creative design, unattractive design detail, large complex and bulky configurations, fixed and unresponsive content, etc. Such unnoticeable designs and limited functionality may prevent the display apparatuses from achieving their purpose of attracting the public's attention. Designs that fail to attract and hold the public's attention or that are uncomfortable or inconvenient to wear can defeat the desirability of providing user wearable display apparatuses particularly where a significant amount of time and resources are employed in creating and distributing the apparatus.

Some user wearable display apparatus include a small light positioned on the surface of the display apparatus to attract attention to the wearable display apparatus. However, the configuration of such user wearable display apparatus is still largely based on a simple painted and/or printed design. The light does not illuminate the surface of the user wearable display from the perspective of an observer. Additionally, the light associated with such user wearable displays will quickly deplete the small batteries utilized with such user wearable displays because they are lit on an ongoing basis. As a result, energy efficient bulbs or other lighting technologies are utilized that tend to lack sufficient brightness to accomplish the original objective for which they were utilized. Alternatively, larger batteries which tend to be expensive and/or heavy may be utilized. This results in additional cost and undesirable weight to the user wearable display. Additionally, an on/off switch may be provided, to help increase battery life when the user wearable display is not being worn. However, when the user wearable display is being worn by the user, the light quickly depletes battery power. In view of the foregoing, there is an ongoing need for display apparatuses that help attract viewers that: are capable of attaching to a user; are more energy efficient; less heavy; and are easily portable.

### BRIEF SUMMARY OF THE INVENTION

The present invention is directed towards a display apparatus that displays information, can respond to and interpret external stimuli so that it can interact with the public, increase the longevity of battery life, and which may be worn by a user, used as a stand-alone display, and/or displayed on another surface (e.g., a signpost, wall, or the like). More specifically, the present invention is directed to an improved display apparatus which provides improved lighting of the surface of the display. For example, according to one aspect of the present invention, the user wearable display includes a light source or lighted display technology that emits light over a substantial surface of the wearable display apparatus so as to accentuate the design of the display apparatus. In one embodiment, a light source of the apparatus may be configured to illuminate a design, provide sequential lighting, and/or provide an interactive display. According to alternative embodiments of the present invention, the invention may also include a promotional display member that displays advertising or sponsoring information in varying degrees of sophistication. This promotional display member may be configured to be attached to the display apparatus and surround or present the design on the front surface of the display apparatus. For example, according to one embodiment the user wearable display includes a video display on the surface of the display apparatus to attract viewers.

According to one aspect of the invention, the user wearable display may be configured to detect external stimulus to determine whether the display apparatus should be actuated. In another aspect of the invention, the battery may be attached to a solar cell. This allows for improved battery life of the display apparatus. In some embodiments, the invention may also include light, sound and motion sensor functionalities of various sophistication singly or together in various configurations on the display apparatus itself or placed remotely attached or wirelessly connected to a microprocessor enabling the interpretation of external stimuli and the varying of the display according to the desired response.

For example, according to one aspect of the invention, a display apparatus, may be fixed in one place (i.e., as a stand-alone display), attached to a surface, and/or designed to be worn by a user. The display apparatus may be directly or wirelessly provided with a controller to allow variability in light, sound or motion sensor functionalities. The display apparatus can include a microprocessor that can interpret external stimuli and vary display output accordingly.

A variety of display technology can be provided in connection with the display apparatus. For example, the display apparatus can include illumination by internal light source such as LED, with or without flashing directed by a microprocessor. According to another aspect of the invention, the display apparatus can include illumination utilizing EL Wire or EL Panel. The display apparatus can include more interactive or active design features such as providing a design or display surface that can be illuminated in sequence, combinations, and/or flashing. According to another aspect of the present invention, the display apparatus can utilize a more sophisticated surface such as television, a liquid crystal display (LCD), super-thin pixilated sheets to display animation or video. The display apparatus may also comprise an audio system to allow the display to output sound. The source of the audio may be a memory disposed on the display apparatus and/or may be an external source in wired and/or wireless communication with the display apparatus. The display apparatus may also comprise other output systems including, but not limited to, video, audio, smell, touch, or the like.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 depicts exemplary use of an interactive wearable display which responds to external stimulus in illustrative operating environment.

FIG. 2 illustrates an exemplary interactive display apparatus according to one aspect of the present invention.

FIG. 3 is a side cross-sectional view of an exemplary display apparatus which includes an illuminated display surface according to one embodiment of the present invention.

FIG. 4 is a side cross-sectional view of an exemplary display apparatus illustrating an exemplary light source for illuminating a display surface according to another embodiment of the present invention.

FIG. 5 illustrates a back surface of a base member of an exemplary display apparatus according to one embodiment of the present invention.

FIG. 6 illustrates a back surface of a base member of an exemplary display apparatus having an enclosed power supply.

FIG. 7 illustrates an exemplary display apparatus having a promotional display member surrounding the display surface and an external power supply according to one embodiment of the present invention.

FIG. 8 is a side cross-sectional view of an exemplary display apparatus utilizing an illumination member and having a microprocessor according to one embodiment of the present invention.

FIG. 9 illustrates the base member and microprocessor of the display apparatus of FIG. 8 according to one embodiment of the present invention.

FIG. 10A illustrates a display member and controller combination which allows a user to selectively actuate the display member according to one embodiment of the present invention.

FIG. 10B illustrates a mechanism for securing the controller to the display member when the display member is not being utilized.

### DETAILED DESCRIPTION OF THE PREFERRED EMBODIMENTS

The present invention is directed towards a display apparatus that can be fixed in one spot as a stand-alone display, attached to a surface, and/or designed to be easily portable and worn by a user for maximum circulation to attract the public's attention and display a message. More specifically, the display apparatus may comprise a light source that emits light and is positioned so as to illuminate the design on the surface of the display apparatus and attract viewers and may contain a microprocessor which can vary the display and which may be directly or wirelessly connected to light, sound or motion-sensor functionalities enabling the interpretation of external stimuli and the varying of the display according to a desired response.

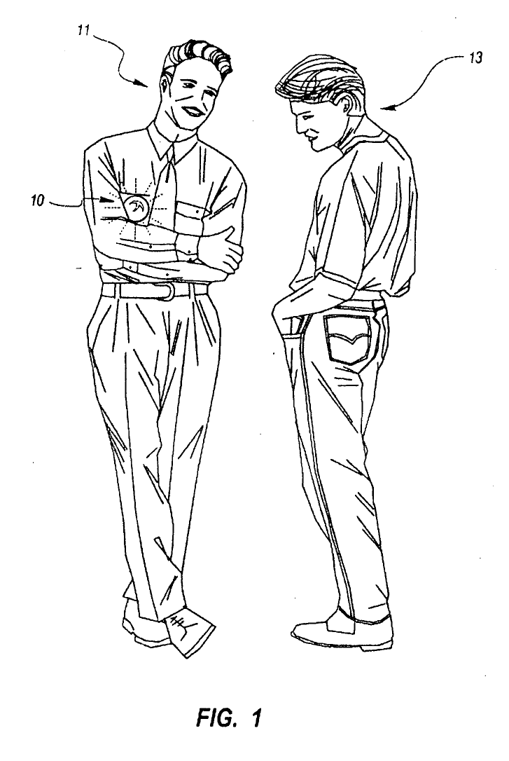

FIG. 1 depicts exemplary use of an interactive wearable display which responds to external stimulus in illustrative operating environment. In the illustrated embodiment, a wearer 11 is wearing display apparatus 10. Display apparatus 10 includes a display surface which is configured to be substantially illuminated. When the display surface is illuminated, the design on the display surface is more clearly visible and attractive to viewers. According to one embodiment of the present invention, the display surface of display apparatus 10 is backlit allowing substantially the entire surface of display apparatus 10 to be lit. Additionally, display apparatus 10 is configured to provide consistent and bright intensity of illumination of the surface of display apparatus 10. By providing consistent and bright intensity of illumination, the lighting of display apparatus is more clearly noticeable and visually attractive.

In the illustrated embodiment, an observer 13 is depicted approaching wearer 11. According to one embodiment of the present invention, display apparatus 10 includes a motion sensing mechanism. As observer 13 approaches wearer 11, the motion sensing mechanism of display apparatus 10 detects movement of observer relative to wearer 11. The motion sensing apparatus actuates the illumination of display apparatus 10. The switching on the illumination of display apparatus 10 changes the display surface of display apparatus from an unlit configuration to a lit configuration. The change from an unlit configuration to a lit configuration draws the attention of observer 13. Additionally, by actuating the illumination of display apparatus 10 only when motion is detected, the total amount of time that display apparatus 10 is actuated is substantially reduced. Because the total amount of time that display apparatus is actuated is substantially reduced, depletion of the power from an energy source such as a battery utilized with the display apparatus is substantially slowed. As a result, display apparatus 10 can be illuminated more brightly and can be utilized for a longer period of time before power from the energy source is depleted.

Display apparatus 10 is configured to detect external stimulus to control actuation of the illumination of display surface. In the illustrated embodiment, display apparatus 10 detects motion of a person or object approaching the display apparatus. As will be appreciated by those skilled in the art, display apparatus can detect a variety of different types of external stimulus without departing from the scope or spirit of the present invention. For example, according to one embodiment of the present invention, the display apparatus detect vibration such as when the wearer is walking or moving to illuminate the display surface. According to another embodiment of the present invention, the display surface is configured to detect sound such as talking, honking of a car horn or other audible signals. According to yet another embodiment of the present invention the display surface is adapted to detect sudden changes in external light sources. According to yet another embodiment of the present invention, the display apparatus is configured to receive an external signal such as from an RF remote, a cell phone, an infrared device, or another remote signal. According to yet another embodiment of the present invention, the display apparatus is configured to detect another variety of external stimulus.

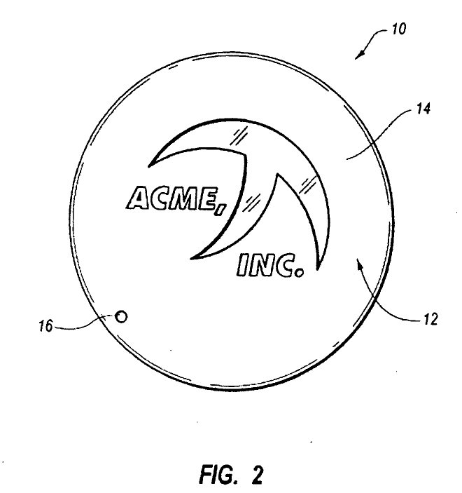

FIG. 2 illustrates display apparatus 10, depicted in FIG. 1 in greater detail according to one embodiment of the present invention. In the illustrated embodiment, display apparatus 10 includes a display surface 12 having a design 14. Display surface 12 comprises the face of display apparatus 10. Display surface 12 also allows light to shine from a light source and illuminate design 14. In the illustrated embodiment, the light source comprises an internal light source positioned behind display surface 12. Display surface 12 is therefore non-opaque (i.e. transparent or translucent) so as to allow for the illumination of light from internal light source 40. (See FIG. 2). In other embodiments, display surface 12 may comprise a video display, such as an LCD screen or the like. In addition, display surface 12 may comprise an audio output, such as an audio speaker or the like (not shown).

As will be appreciated by those skilled in the art, a variety of configurations or types of display surface 12 can be utilized to allow a light source to illuminate a design. Display surface 12 may also be variously shaped or sized, such as being round, square, rectangular, curved, non-curved, or any other geometric shape or size. In one embodiment, the shape of display apparatus 10 can influence the shape of display surface 12.

Design 14 is configured to portray information or designs on design surface 12. Design 14 is illuminated by light emitted from a light source. Illumination of design 14 can accentuate the design to users. In the illustrated embodiment display apparatus 16 includes a motion sensor 16. According to one embodiment of the present invention, design 14 is illuminated when motion sensor 16 detects that a person or object is approaching display apparatus 10. As a result, when design 14 changes from a non-illuminated configuration to an illuminated configuration, the observer's attention will be drawn to display apparatus and in particular to design 14. As will be appreciated by those skilled in the art, a variety of types and configurations of designs can be utilized without departing from the scope and spirit of the present invention. The design can be independently connected to or be an integral part of display surface and can extend on one or a combination of surfaces of display surface including the front, sides, and top and bottom. A number of types and configurations of designs can be included on the display surface, such as, but not limited to, characters, words, letters, number, shapes, pictures, slogans, advertisements, and any other design that will capture the attention of the public. Additionally, the display apparatus can be circular, non-circular, any geometric shape, multi-dimensional, thin, thick, have protruding or concave surfaces, or be any other configuration as needed. The display apparatus can also include variations in style or design in displaying their respective information. The display apparatus can be of an assortment of colors, words, letters, numbers, shapes, sizes or any other design known to those common in the art to display their information to be viewed by other persons. In addition, the display apparatus may comprise a video/image display device, such as an LCD, or the like and/or an audio output (e.g., audio speaker, or the like) (not shown).

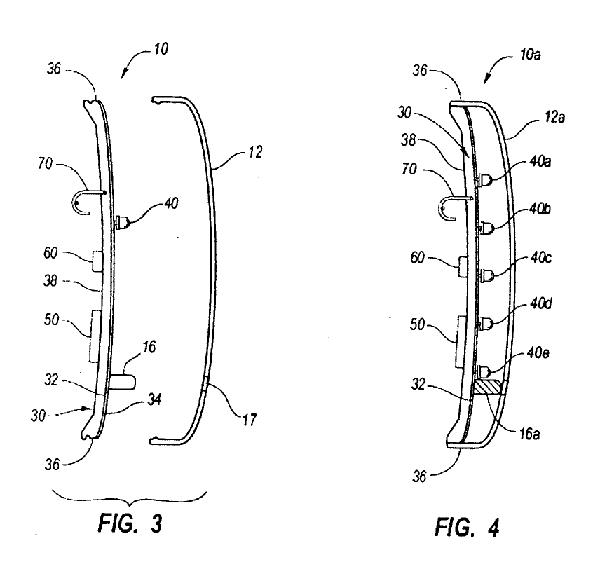

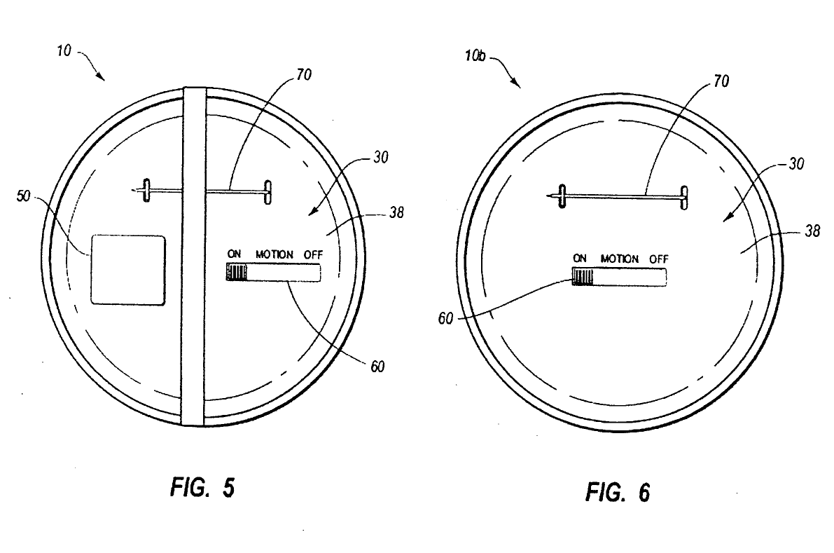

FIG. 3 is a cross-sectional side view of an exemplary display apparatus 10 illustrating the components of display apparatus 10 according to one embodiment of the present invention. In the illustrated embodiment, display apparatus 10 comprises a display surface 12, a reflective member 32, a light source 40, a power supply 50, an actuation mechanism 60, an attachment apparatus 70, and a promotional display member 80 (see FIG. 6).

As previously discussed, display surface 12 is configured to be positioned such that it is visible to a viewer. In one embodiment, display apparatus 10 is non-opaque in whole, or in part, to allow illumination of display surface 12. For example, in one embodiment, a design of the display surface is translucent while the non-design portion of the display surface is opaque to accentuate the shape of the design relative to the background display surface. According to another illustrative example, the design of the display surface is transparent, while the rest of the display surface is translucent to accentuate the design of the display surface but while also providing for illumination of the entire display surface. According to another embodiment, a light source is positioned to illuminate display surface from other than a backlighting configuration. For example, a light source could be positioned adjacent to, or slightly in front of, the display surface to illuminate the display surface.

Base member 30 provides a support structure on which other components of display apparatus 10 are positioned. Base member 30 includes a front surface 34, sides 36a, b, and a back surface 38. Display surface 12 is configured to be secured to base member 30. As will be appreciated by those skilled in the art, a variety of types and configurations of a connection between display surface 12 and base member 30 can be utilized without departing from the scope and spirit of the present invention. For example, in one embodiment notches are included on a display surface that fit into corresponding grooves on a base member or vice versa. In an alternative embodiment, the display surface is threadably coupled to the base member. In yet another embodiment, a display surface is adhesively attached or affixed to the base member.

Reflective member 32 provides a surface that reflects light toward display surface 12 so as to illuminate design 14. Reflective member 32 can be connected to front surface 34 and possibly sides 36a, b of base member 30. In the illustrated embodiment, reflective member 32 is positioned behind light source 40 to accentuate and deflect light emitted from light source 40. By accentuating light emitted from light source 40, less candle power need be provided by light source 40 to achieve a desired degree of illumination. In one embodiment, reflective member 32 is adhesively attached to base member 30. By deflecting light emitted from light source 40, a more generalized illumination is provided rather than a point specific type of illumination. In other words, light source provides a consistent lighting over the entire surface of display surface 12 rather than just providing a point specific or partial lighting of the surface of display surface 12. According to one embodiment of the present invention, a diffusion apparatus is provided such that most, or all of the light, illuminating display surface 12 is diffused by a reflective or other surface.

In the illustrated embodiment motion sensor 16 is depicted. Motion sensor 16 is secured to front surface 34 of base member 30. Motion sensor 16 extends distally from front surface 34 of base member 30 in the direction of display surface 12. In the illustrated embodiment, display surface 12 includes a window 17 which accommodates the distal end of motion sensor 16. In this manner, display surface 12 permits motion sensor 16 to detect movement external to display apparatus 10 without obfuscating the operation and motion detection capabilities of motion sensor 16.

In the illustrated embodiment, motion sensor 16 is operably connected to light source 40. The motion sensing apparatus 16 actuates light source 40 to illuminate display surface 12 of display apparatus 10. By actuating light source 40 of display apparatus 10, display surface 12 of display apparatus changes from an unlit configuration to an illuminated configuration. The change from an unlit configuration to an illuminated configuration draws the attention of people in the vicinity of display apparatus 10. Additionally, by actuating the illumination of display apparatus 10 only when motion is detected, the total amount of time that display apparatus 10 is actuated is substantially reduced. Because the total amount of time that display apparatus is actuated is substantially reduced, length of time during which power supply 50 will have sufficient energy to illuminate light source 40 is significantly extended. As a result, a higher candle power light source 40 can be utilized which will provide a brighter and more consistent lighting of display surface 12 without concern of the premature depletion of power supply 50.

As will be appreciated by those skilled in the art, a variety of types and configurations of connections between a base member and a reflective surface can be utilized without departing from the scope and spirit of the present invention. For example, in one embodiment the reflective surface is an integral part of the front surface of a base member. Other methods for providing a reflective surface can be utilized without departing from the scope and spirit of the present invention.

Reflective member 32 can be composed of a variety of materials configured to reflecting or mirroring light, such as glass, metal, plastic, or other reflective materials, including materials coated with shiny or reflective paint, coatings, or substances. Light may also be diffused by refraction either through interposition of supplementary member or surface which includes light refraction qualities. For example a supplementary member can be translucent or provide light refraction due to the shape of reflective member 32 so that the different angles direct the light through the display surface as desired. The shape and size of reflective member 32 can be selected to accommodate the shape and design of base member 30 or display apparatus 10. According to another embodiment, the shape/size of a reflective member is not the same as the shape/size of a base member or display apparatus. The cross-sectional diameter of reflective member 32 can also vary according to the type of reflective material used. As will be appreciated by those skilled in the art, a variety of types and configurations of reflective members can be utilized without departing from the scope and spirit of the present invention. According to another embodiment of the present invention, the display apparatus includes a gobo or other image projections apparatus for conveying an image on a surface.

Light source 40 provides a mechanism for illuminating display surface 12. Light source 40 provides a desired degree of illumination to achieve a desired effect on display surface and or a design positioned on display surface 12. The light source 40 can provide a light source for illumination of or on the display surface that is constant or intermittent, as by flashing. A variety of types and configuration of light sources can be utilized without departing from the scope and spirit of the present invention. According to one embodiment of the present invention, the light source comprises a light emitting diode (“LED”). According to another embodiment of the present invention, the light source is selected from the group including incandescent bulbs, neon bulbs, florescent bulbs, light emitting chemicals, or other sources of light.

In the illustrated embodiment, light source 40 is configured to connect to a portion of base member 30. In the illustrated embodiment, light source 40 is connected to a front surface 34 and/ or sides 36a, b of base member 30. As will be appreciated by those skilled in the art, a variety of types and configurations of mechanisms can be utilized to secure light source 40 to the display apparatus 10 without departing from the scope and spirit of the present invention. For example, according to one embodiment of the present invention the light source is attached to a component of the display apparatus other than the base member. In one embodiment, the light source is integrally coupled to the base member. According to another embodiment, the light source is suspended between the base and display surfaces to take advantage of reflective and refractive qualities of the base surface and any member interposed between the base surface and the display surface. According to another embodiment, the light source is attached to the display surface itself in one or more places or design configurations so as to concentrate or diffuse light in one or more places or as to outline a design or particular elements of a design on part of the display surface. Different light configurations may be utilized to concentrate or diffuse light in different ways either to illuminate all or part of the display surface or to concentrate light on one or more parts of the display surface. As will be appreciated by those skilled in the art a variety of types and configurations of light sources can be utilized with the display apparatus in a variety of manners without departing from the scope and spirit of the present invention.

In the illustrated embodiment, power supply 50 provides power to display apparatus 10 and specifically to light source 40. Power supply 50 can comprise a battery pack or other source of power for light source 40. Power supply will be discussed in greater detail with reference to FIG. 5.

Actuation mechanism 60 provides a mechanism which allows the user to turn off display apparatus 10 or allow for normal operation of display apparatus, as shown in FIG. 3. Actuation mechanism 60 can include a moveable switch or device than enables a user to move actuation mechanism 60 from one position to another. Back surface 38 of base member 30 is configured to attach to actuation mechanism 60. Actuation mechanism 60 is connected to base member 30 such that actuation mechanism 60 partially extends outward from back surface 38 so as to allow a user to adjust actuation mechanism 60. Actuation mechanism will be discussed in greater detail with reference to FIG. 4.

Attachment apparatus 70 provides a mechanism for allowing display apparatus 10 to be worn by a user and/or attached to a surface. In the illustrated embodiment, attachment apparatus 70 is connected to back surface 38 or sides 36 of base member 30 and is capable of being attached to a user. Attachment apparatus 70 is connected to base member 30 and partially extends outward from back surface 38 or from sides 36 so as to allow a user to employ attachment apparatus 70.

FIG. 4 illustrates a cross-sectional view of a display apparatus 10a having a plurality of light sources. In the illustrated embodiment, display surface 12a is integrally coupled to base member 30. A plurality of light sources 40a-e are coupled to base member 30. By providing a plurality of light sources 40a-e, a more diffused and consistent amount of lighting is provided from the top of display surface 12a to the bottom of display surface 12a.

As will be appreciated by those skilled in the art, a variety of configurations and numbers of light sources can be provided without departing from the scope and spirit of the present invention. For example, in one embodiment, a plurality of lights are positioned on the entire surface area of the base member to equally cover the base member. According to another embodiment, the number and configuration of the light sources are selected to provide a desired effect on the display surface and/or a design positioned on the display surface.

In the illustrated embodiment, a vibration detector 16a is provided in connection with display apparatus 10a. Vibration detector 16a detects when display apparatus 10 is being moved such as when a user is walking or when display apparatus is picked up by a user. Vibration detector 16a is operably coupled to light sources 40a-e. According to one embodiment of the present invention, when vibration detector 16a detects vibration such as is associated with movement of display apparatus 10a, light sources 40a-e are actuated for a predetermined amount of time. According to one aspect of the present invention, a mechanism for detecting external stimulus such as vibration detector 16a is utilized in connection with a microprocessor, microcontroller or other control device. The microprocessor or other control device can be utilized to create a desired output and/or analyze input received from the mechanism for detecting external stimulus to control actuation of the display apparatus.

For example, according to one exemplary embodiment, a microprocessor will not actuate the light source unless a vibration detector experiences at least 3 occurrences of vibration over a two minute period or continuous vibration of more than 5 seconds. In this manner, it is likely that a user is walking. In this manner, in the event that the display apparatus being stored in a drawer, simply opening and closing the drawer will not actuate illumination of the display apparatus. However, if the user places the display on a backpack and proceeds to walk to work or school, the display apparatus will be actuated for a predetermined amount of time. In the event that the user then places the backpack in a locker or in an office, the display apparatus will automatically turn off illumination after a predetermined period of time, such as after 30 minutes. In this manner, the energy of the power source will be conserved.

According to another embodiment of the present invention, the mechanism for detecting external stimulus can actuate desired operability of the illumination source. For example, a sequence of illumination can be initiated upon detecting certain external stimulus. In one embodiment, alternating lights or a desired sequence of lighting can be initiated. Alternatively, an audible signal can be initiated in response to the detection of an external stimulus. In yet another embodiment a combination of audible and visual actuation can be commenced in response to external stimulus. For example in one embodiment of the present invention, when a motion sensor detects that a person is approaching, a microprocessor could actuate a series of lighting of a display surface while an audible signal is initiated. For example, in sequence the words, “Joe for President” could be sequentially lighted while a short song is played by the display apparatus.

FIG. 5 illustrates the back surface of base member 30 showing a power supply 50 which is partially covered and an actuation mechanism 60. In the illustrated embodiment, a portion of power supply 50 extends outward from base member 30 and is visible. The amount which power supply 50 extends outward from base member 30 can be selected to result in minimal contact with the user. A variety of types and configurations of power supplies can be utilized without departing from the scope and spirit of the present invention, including but not limited to, battery-operated, rechargeable battery-operated, solar powered, AC powered, DC powered, and other power supplies typically used by those skilled in the art.

A variety of types and configurations mechanisms for securing a base member to a power supply can be utilized without departing from the scope and spirit of the present invention. For example, in the illustrated embodiment a power supply that is only partially covered by a base member and therefore a portion of the power supply may extend outward from the back surface of a base member. In yet another embodiment, a power supply may be completely covered by or located within a base member. In an alternative embodiment, an external power supply is utilized wherein the power supply is located outside of a display apparatus and is connected to the base member and light source by a connection device such as an electrical cord, electrical wire, power cord, etc.

Actuation mechanism 60 may be positioned adjacent power supply 50. In the illustrated embodiment, actuation mechanism can be utilized to select three different operating states. An “on” operating mode in which the illumination source is continually lighted. A “motion” operating mode in which display apparatus 10 is actuated in response to certain external stimulus. And an “off” mode in which display apparatus 10 is not actuated. Actuation mechanism allows a user to actuate or deactuate light source 40 (see FIG. 2), audio, and/or video display functionality, or the like. In the illustrated embodiment actuation mechanism 60 is remotely connected to power supply 50.

As will be appreciated by those skilled in the art, a variety of types and configurations of attachment between actuation mechanism 60 and power supply 50 can be utilized without departing from the scope and spirit of the invention. In one embodiment, actuation mechanism 60 and power supply 50 are connected utilizing electrical wiring 90 (see FIG. 6). The electrical wiring allows the current of power supply 50 to be activated or deactivated by moving actuation mechanism 60 from a first position to a second or third position or “on and off” or flashing position.

As will be appreciated by those skilled in the art, a variety of types and configurations of a connection between a base member and an actuation mechanism can be utilized without departing from the scope and spirit of the present invention. In one embodiment, actuation mechanism is integrally formed with a power supply. For example, in the illustrated preferred embodiment, an actuation mechanism is remotely connected to a partially covered power supply by a connection device such as an electrical wire. In alternative embodiments, an actuation mechanism may be integrally connected to an internal power supply but is configured to extend outward from the back surface of a base member to be actuated by a user. The present invention includes a variety of types of switches/devices which can be utilized used in the art for such purposes. In one embodiment, the actuation mechanism is a switch that extends from the back surface or side of a base member that is moveable from a first position to a second position, thereby activating or deactivating a power supply. In another embodiment, a dial or push button control panel is utilized.

In the illustrated embodiment, display apparatus includes an attachment apparatus 70 in the form of a pin. A variety of types and configurations of attachment apparatuses that are capable of affixing a display apparatus to a user can be utilized with display apparatus 10. As will be appreciated by those skilled in the art, the particular mechanism for securing base member to an attachment apparatus can be selected from a wide range of apparatus. For example, an attachment apparatus can be adhesively attached or affixed to a base member utilizing known methods. The type of attachment apparatus 70 can be used to determine the correct placement and connection of attachment apparatus 70 to base member 30.

As will be appreciated by those skilled in the art, a variety of types and configurations of connections between the base member and the attachment apparatus can be utilized without departing from the scope and spirit of the present invention. For example, the attachment apparatus be adhesively attached or affixed to a base member utilizing known methods. The type of attachment apparatus 70 can be used to determine the correct placement and connection of attachment apparatus 70 to base member 30.

As will be appreciated by those skilled in the art, a variety of types and configurations of an attachment apparatus can be utilized without departing from the scope and spirit of the present invention. For example, in one embodiment the attachment apparatus comprises a pin that is connected to the back surface of a base member and is capable of being pinned onto a user's clothing. According to another embodiment a clamp is utilized that is connected to the back surface of a base member and can slide onto a user's shirt pocket or other article of clothing. In yet another embodiment, the top side surface of a base member can be connected to a neck tie that is worn around a user's neck and allows a display apparatus to hang close to the user's chest. These examples are non-limiting and the present invention includes all types of attachment apparatus that are commonly known and used in the art.

FIG. 6 illustrates an exemplary display apparatus 10b showing a back surface 38 of base member 30. In the illustrated embodiment, a power supply is positioned internal to base member 30 with the power supply being completely enclosed by back surface 38 of base member 30. This allows the power supply to be effectively isolated from a user wearing user wearable display 10b. In one embodiment, an actuation mechanism can be integrally connected to an internal power supply and is configured to be the only component that extends outward from the back surface of a base member. According to another embodiment, the actuation mechanism is remotely connected to an internal power supply by an electrical wire, radio frequency (RF) signal, ultra-high frequency (UHF) signal, remote infrared device, or other connection device known to those skilled in the art

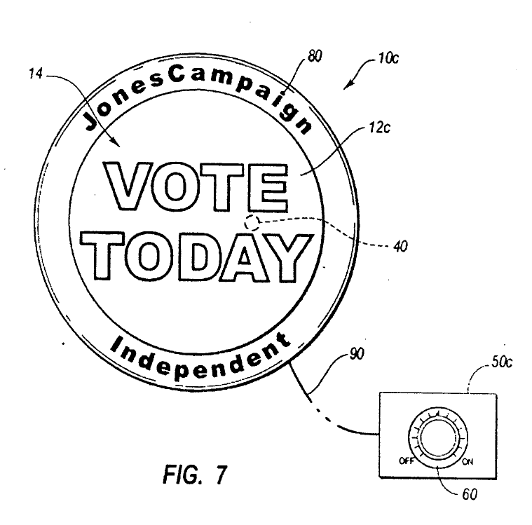

FIG. 7 illustrates a display surface 12c of a display apparatus 10c having a promotional border 80 and an external power supply 50c. Design 14c is positioned on display surface 12c and is illuminated by an internal light source 40 positioned internal to display surface 12c. In the illustrated embodiment, a promotional display member 80 is positioned adjacent display surface 12c. Promotional display member 80 displays advertising, sponsoring, or other types of information. As discussed above, in alternative embodiment design 14c may comprise an LCD video display and/or audio output.

In the illustrated embodiment, promotional display member 80 surrounds display surface 12c. Promotional display member 80 can be an integrally coupled to other components of display apparatus 10c or selectively couplable to display apparatus 10c. In one embodiment, a different display member 80 can be exchanged for a display member currently being utilized. The display member 80 can be utilized for sponsorship, promotional, informational material. For example, manufacturing and distribution of a pin can be paid for by selling the advertising space of the promotional display member.

A variety of different types and configurations of display members can be utilized without departing from the scope and spirit of the present invention. For example, in one embodiment, the display member is positioned across a portion or underneath the pin rather than circumscribing the display surface. According to another embodiment, the display member is configured to be attached to the top, bottom, side, or other surface of the apparatus. According to another embodiment, the shape of the display member corresponds to the shape of the display surface. For example, in one embodiment, a rectangular display member is attached to the top and/or bottom of a rectangular display surface. As will be appreciated by those skilled in the art, a variety of types and configurations of connections between promotional display member and other components of the display apparatus can be utilized without departing from the scope and spirit of the present invention. For example, in one embodiment, one or more sides of a base member include grooves in which protrusions from a promotional display member attach. In an alternative embodiment, the inner edge of promotional display member slides into a continuous groove that is provided surrounding the sides of a base member. In yet other embodiments, a promotional display member can be adhesively attached or affixed to a base member.

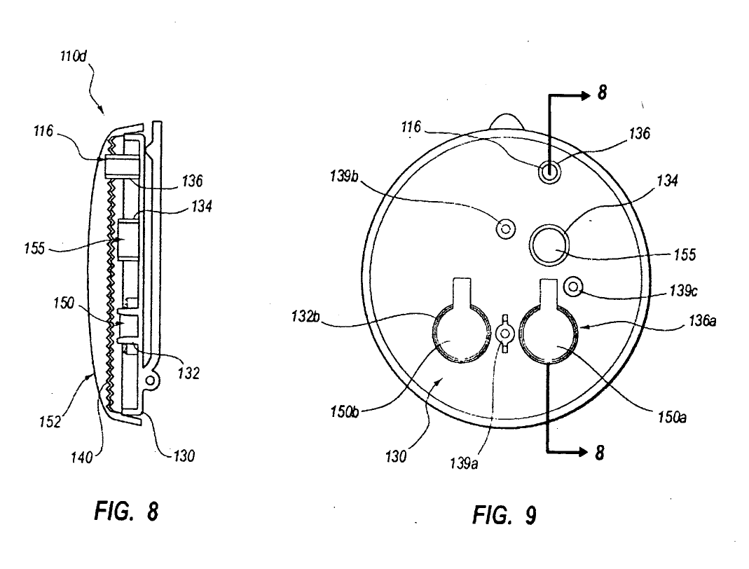

FIG. 8 is side cross-sectional view of a display apparatus 110 according to one embodiment of the present invention. In the illustrated embodiment, display apparatus 110 comprises a display surface 112, a mechanism for detecting external stimulus 116, a base member 130, an illumination member 140, a power supply 150 and a microprocessor 155.

In the illustrated embodiment, illumination member 140 is positioned between display surface 112 and base member 130. Illumination member 140 provides a consistent and even illumination of the desired portions of display surface 112. In the illustrated embodiment, illumination member comprises EL Panel or EL Wire. EL Panel and EL Wire provide a consistent illumination over the entire surface of display surface 112. Traditionally, EL Wire and EL Panel have not been favored for wearable displays or any display that could potentially result in contact between the EL Wire and EL Panel and outside objects and materials. This is due to the fragile or bendable nature of EL Wire and EL Panel. When EL Wire and EL Panel are contacted by outside objects and materials and/or is presented without backing support, it tends to bend, distort, and otherwise lose its consistent and professional appearance.

Display Apparatus provides a design and configuration which allows for the use of EL Wire and EL Panel while still maintaining both a consistent long term performance and consistent uniformity and professionalism of the appearance of the EL Wire and EL Panel. In the illustrated embodiment, display surface 140 and base member 130 provides securement to one or more portions of illumination member 140 such that illumination member maintains a desired uniformity within display apparatus 110. For example, in one embodiment illumination member 140 is sandwiched between illumination member 140 and base member 130. The illumination member 140 can be mounted on a mounting bracket of base member 130 which encompasses a substantial portion of the circumference of both illumination member 140 and base member 130. Additionally, supplemental points of securement can be provided which do not lie on the circumference of either illumination member 140 or base member 130. Additionally, display surface 112 is also positioned in apposition with the front surface of illumination member preventing bending, kinking of the illumination member 140. Illumination member is one example of a light source.

With reference now to FIG. 8 and FIG. 9, in the illustrated embodiment, base member 130 includes a power source housing 132 a, b, microprocessor housing 134, external input sensor housing, and securement posts 139a, b, c, d. Securement posts 139a, b, c, d are utilized to secure base member to display surface 112. Power source housing 132a, b are configured to hold power supplies 150a, b. In the illustrated embodiment, power supplies 150a, b may comprise coin shaped batteries which provide power to illumination member 140.

Microprocessor housing 134 secures microprocessor 155 within microprocessor housing 134. Microprocessor 134 is discussed for exemplary purposes, as will be appreciated by those skilled in the art, a microcontroller, integrated circuit or other control device can be utilized in place of a microprocessor without departing from the scope and spirit of the present invention. Additionally, it will be understood that functionality described with reference to microprocessor 134 can be provided by alternative control apparatus and should not be considered to be limiting in nature.

According to one aspect of the present invention, microprocessor 155 is utilized in connection with the mechanism for detecting external stimulus 116 to, at least in part, control operation of display apparatus 110. Microprocessor 155 can be utilized to create a desired output and/or analyze input received from the mechanism for detecting external stimulus to control actuation of the display apparatus.

For example, according to one exemplary embodiment, microprocessor 134 will not actuate the light source unless a vibration detector experiences at least 3 occurrences of vibration over a two minute period or continuous vibration of more than 5 seconds. In this manner, it is likely that a user is walking. In this manner, in the event that the display apparatus being stored in a drawer, simply opening and closing the drawer will not actuate illumination of the display apparatus. However, if the user places the display on a backpack and proceeds to walk to work or school, the display apparatus will be actuated for a predetermined amount of time. In the event that the user then places the backpack in a locker or in an office, the display apparatus will automatically turn off illumination after a predetermined period of time, such as after 30 minutes. In this manner, the energy of the power source will be conserved.

According to another embodiment of the present invention, the mechanism for detecting external stimulus can actuate desired operability of the illumination source. For example, a sequence of illumination can be initiated upon detecting certain external stimulus. In one embodiment, alternating lights or a desired sequence of lighting can be initiated. Alternatively, an audible signal can be initiated in response to the detection of an external stimulus. In yet another embodiment a combination of audible and visual actuation can be commenced in response to external stimulus. For example in one embodiment of the present invention, when a motion sensor detects that a person is approaching, a microprocessor could actuate a series of lighting of a display surface while an audible signal is initiated. For example, in sequence the words, “Joe for President” could be sequentially lighted while a short song is played by the display apparatus.

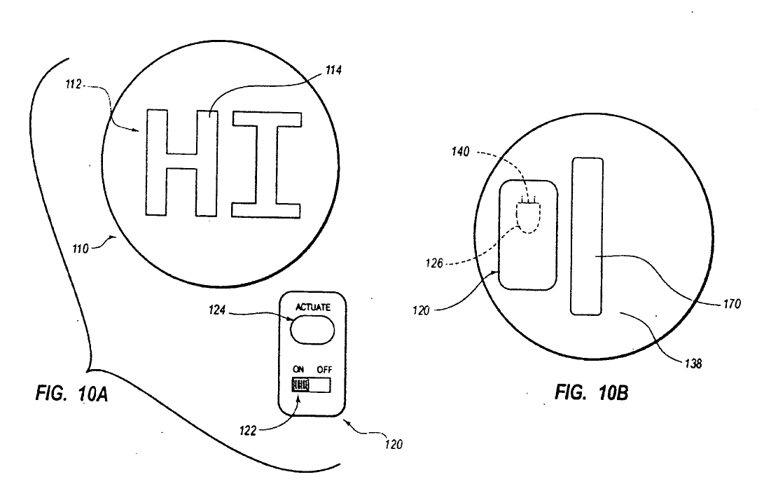

FIGS. 10A and 10B depict a display apparatus 110 for use with controller 120. In the illustrated embodiment, controller 120 allows a user to remotely actuate a light source utilized in connection with display apparatus 110. As a result, a user could have the display apparatus positioned on a coat placed on one side of the room and illuminate the design 114 of display apparatus utilizing controller 120.

In the illustrated embodiment, controller 120 includes an on/off switch 122 and an actuation button 124. On/off switch 122 allows a user to select between an on position in which display apparatus can be actuated and an off position in which display apparatus cannot be actuated. Actuation button 124 allows the user to selectively actuate the light source utilized in connection with display apparatus 110.

As depicted in FIG. 10B, a back surface 138 of display apparatus 110 includes a mounting bracket 140. Mounting bracket 140 provides a mechanism allowing controller 120 to be secured to display apparatus 110 when display apparatus 110 and controller 120 are not being utilized. In the illustrated embodiment, a clip 126 of controller 120 can be clipped over mounting bracket 140 to secure controller 120 relative to display apparatus 110. By providing a mechanism for securing controller 120 relative to display apparatus 110 when controller 120 and display apparatus 110 are not in use, it is easier to keep track of the location of both of controller 120 and display apparatus before the next subsequent use of display apparatus 110.

As will be appreciated by those skilled in the art, a variety of remote mechanisms can be utilized without departing from the scope and spirit of the present invention. For example, according to one embodiment of the present invention, display apparatus can be utilized with an RF controller, infrared controller, mobile phone signal or the like.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A display comprising:
a display surface configured to have at least a portion of the display surface illuminated;
a light source utilized in connection with display surface that emits light so as to illuminate at least a portion of the display surface;
a power source operably connected to the light source to provide power to allow for actuation of the light source; and
a mechanism configured to detect an external stimulus, wherein the mechanism configured to detect an external stimulus is utilized to control actuation or deactuation of the light source.

2. The display of claim 1, wherein the mechanism configured to detect an external stimulus comprises a motion sensor.

3. The display of claim 1, wherein the mechanism configured to detect an external stimulus comprises a vibration sensor.

4. The display of claim 1, wherein the mechanism configured to detect an external stimulus comprises a light sensor.

5. The display of claim 1, further comprising a controller which can be utilized to remotely actuate the light source of the user wearable display.

6. The display of claim 1, wherein the light source comprises one or more Light Emitting Diodes.

7. The display of claim 1, wherein the light source comprises EL Wire.

8. The display of claim 1, wherein the light source comprises EL Panel.

9. The display of claim 1, further comprising a microcontroller.

10. The display of claim 9, wherein the microcontroller controls actuation or deactuation of the light source based at least in part on whether the mechanism configured to detect an external stimulus has a predetermined type of external stimulus.

11. A display comprising:
a display surface having at least a portion that is non-opaque;
a design positioned on the display surface;
a light source positioned behind the non-opaque display surface that emits light so as to provide greater visibility of the design positioned on the display surface;
a power supply capable of providing power to the light source; and
an actuation mechanism that activates or de-activates the power supply.

12. The display of claim 11, wherein the non-opaque portion of the display surface is translucent.

13. The display of claim 11, wherein the non-opaque portion of the display surface is transparent.

14. The display of claim 11, wherein the display surface includes a translucent portion and a transparent portion.

15. The display of claim 11, wherein the display has a removable and replaceable promotional display member with a design usually used for advertising purposes.

16. The display of claim 11, wherein the light source comprises one or more light emitting diodes.

17. The display of claim 16, wherein the light emitting diodes can be actuated and deactuated to create desired visual effects.

18. The display of claim 11, further comprising a logic module for use with the light source to create varying visual effects during operation.

19. The display of claim 18, wherein the logic module actuates or deactuates one or more portions of the light source to create desired visual effects during operation.

20. A display apparatus designed to be worn by a user comprising:
a semi-transparent display surface;
a design on the face of the display surface that can be variously configured so as to suit various purposes;
a supporting base member;
a reflective member on or near the base member that reflects light;
one or more light emitting diodes on or near the base member that is capable of emitting light;
a self-contained battery that may be connected to a solar charging cell that is used to provide power to the light emitting diode;
an on-off switch used to active or deactivate the battery; and
a form of attachment so as to attach the display apparatus to the user.
